(19) United States
(12) Patent Application Publication
(10) Pub. No.: US 2025/0004008 A1
(43) Pub. Date: Jan. 2, 2025

(54) SEMICONDUCTOR DEVICE

(71) Applicant: Renesas Electronics Corporation, Tokyo (JP)

(72) Inventor: Shintaro NAKAMURA, Tokyo (JP)

(73) Assignee: Renesas Electronics Corporation, Tokyo (JP)

(21) Appl. No.: 18/756,327

(22) Filed: Jun. 27, 2024

(30) Foreign Application Priority Data
Jun. 30, 2023 (JP) 2023-108002

(51) Int. Cl. G01P 15/18; G01P 15/14; G03B 5/00

(52) U.S. Cl. CPC G01P 15/18; G01P 15/14; G03B 5/00; G03B 2205/0007

(57) ABSTRACT

A semiconductor device includes: a camera lens that controls an X axis, a Y axis, and a Z axis to perform camera shake correction; a first semiconductor chip that receives data of the X axis and the Y axis of the camera lens; a second semiconductor chip that receives data of the Z axis of the camera lens; and a gyro sensor that acquires camera shake state data, in which the second semiconductor chip is connected to the first semiconductor chip via a chip select signal line, a data signal line, and a clock signal line of SPI communication, and is connected to the gyro sensor via the chip select signal line, the data signal line, and the clock signal line of the SPI communication, and the second semiconductor chip transmits position data of the Z axis to a storage unit of the gyro sensor via the SPI communication.

### CROSS-REFERENCE TO RELATED APPLICATION

The subject application claims priority under 35 U.S.C. § 119 to Japanese Patent Application No. 2023-108002 filed on Jun. 30, 2023. The entire disclosure of Japanese Patent Application No. 2023-108002 is incorporated herein by reference.

### BACKGROUND

The present disclosure relates to a semiconductor device.

In video cameras or digital cameras, camera shake correction using one or both of an optical image stabilizer (OIS) and an electronic image stabilizer (EIS) is performed.

There is disclosed a technique listed below.
[Patent Document 1] Japanese Unexamined Patent Application Publication No. 2019-106655

Patent Document 1 discloses a semiconductor device that reduces the risk that either of an OIS and an EIS is outside a correctable range when the OIS and the EIS are used in combination. The semiconductor device adjusts a position of a correction lens for use in optical camera shake correction based on information representing a present position of the correction lens and position information of an output image of electronic camera shake correction with respect to a photographed image photographed by an imaging element. As a result, an operation margin of the correction lens is kept, while keeping a correction margin for the electronic camera shake correction.

### SUMMARY

Although it is possible to share pieces of data of two semiconductor chips using SPI communication in which a chip select signal line is used for communication between the two semiconductor chips, there is a problem that wirings increase. Therefore, an object of the present disclosure is to provide a semiconductor device that transmits and receives data using an unused address of a gyro sensor to reduce the number of wirings.

Other problems and novel features will be apparent from description of the present specification and the attached drawings.

According to one embodiment, in a semiconductor device, a second semiconductor chip transmits data to a storage unit of a gyro sensor via SPI communication, and a first semiconductor chip uses the data.

According to the above embodiment, it is possible to provide the semiconductor device that transmits and receives data using the unused address of the gyro sensor to reduce the number of wirings.

### BRIEF DESCRIPTION OF THE DRAWINGS

FIG. 1 is a block diagram illustrating a configuration of an image stabilizer, which controls a three-axis OIS lens using two two-axis OIS-ICs (integrated circuits), according to a first embodiment.

FIG. 2 is a sequence diagram of an OIS process according to the first embodiment.

FIG. 3 is a block diagram illustrating an X-axis correction process using a Z-axis lens position in the OIS process according to the first embodiment.

FIG. 4 is a schematic diagram illustrating an unused area of a data address of a gyro sensor in the OIS process according to the first embodiment.

FIG. 5 is a flowchart illustrating an operation of a primary semiconductor chip of the two-axis OIS-IC in the OIS process according to the first embodiment.

FIG. 6 is a flowchart illustrating an operation of a secondary semiconductor chip of the two-axis OIS-IC in the OIS process according to the first embodiment.

FIG. 7 is a sequence diagram of an OIS process according to a second embodiment.

FIG. 8 is a flowchart illustrating an operation of a primary semiconductor chip of a two-axis OIS-IC in the OIS process according to the second embodiment.

FIG. 9 is a flowchart illustrating an operation of a secondary semiconductor chip of the two-axis OIS-IC in the OIS process according to the second embodiment.

FIG. 10 is a flowchart illustrating an operation of a host controller in the OIS process according to the second embodiment.

FIG. 11 is a view illustrating content examples of EIS data according to the second embodiment.

FIG. 12 is a view illustrating content examples of EIS data according to a related technique.

FIG. 13 is a sequence diagram of an OIS process according to a third embodiment.

FIG. 14 is a schematic diagram illustrating an unused area of a data address of a gyro sensor in the OIS process according to the third embodiment.

FIG. 15 is a block diagram illustrating a configuration of an image stabilizer, which controls a plurality of two-axis OIS-ICs and two-axis OIS lenses respectively connected to the two-axis OIS-ICs, according to a fourth embodiment.

FIG. 16 is a sequence diagram of an OIS process according to the fourth embodiment.

FIG. 17 is a flowchart illustrating an operation of a primary semiconductor chip of the two-axis OIS-IC in the OIS process according to the fourth embodiment.

FIG. 18 is a flowchart illustrating an operation of a secondary semiconductor chip of the two-axis OIS-IC in the OIS process according to the fourth embodiment.

FIG. 19 is a schematic diagram illustrating an unused area of a data address of a gyro sensor in the OIS process according to the fourth embodiment.

FIG. 20 is a flowchart illustrating an operation of a host controller in the OIS process according to the fourth embodiment.

FIG. 21 is a diagram illustrating a time required for the OIS process according to the fourth embodiment and a time required for an OIS process according to a related technique.

FIG. 22 is a sequence diagram of an OIS process according to a fifth embodiment.

### DETAILED DESCRIPTION

The following description and the drawings are omitted and simplified as appropriate to clarify the description. Further, each of elements described in the drawings as functional blocks performing various processes can be configured by a CPU, a memory, and other circuits in terms of hardware, and is implemented by a program loaded in the memory or the like in terms of software. Therefore, it is understood by those skilled in the art that these functional blocks can be implemented in various forms by only hardware, only software, or a combination thereof without being limited to any of them. In the drawings, the same elements are denoted by the same reference numerals, and redundant description is omitted as necessary.

### (Description of Image Stabilizer According to First Embodiment)

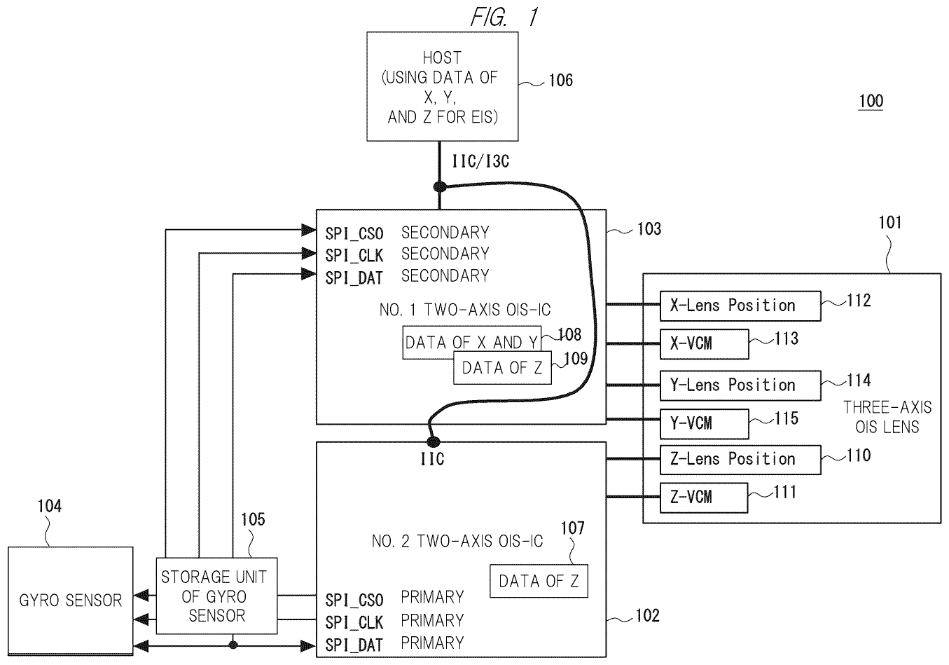

FIG. 1 is a block diagram illustrating a configuration of an image stabilizer, which controls a three-axis OIS lens using two two-axis OIS-ICs, according to a first embodiment. The image stabilizer according to the first embodiment will be described with reference to FIG. 1. An image stabilizer 100 is a semiconductor device that is used in an imaging apparatus to correct a camera shake. The image stabilizer 100 corrects the camera shake of the three-axis OIS lens using the two two-axis OIS-ICs.

As illustrated in FIG. 1, the image stabilizer 100 according to the first embodiment includes a three-axis OIS lens (hereinafter, referred to as camera lens) 101, a No. 1 two-axis OIS-IC (hereinafter, referred to as first semiconductor chip) 103, a No. 2 two-axis OIS-IC (hereinafter, referred to as second semiconductor chip) 102, a gyro sensor 104, and a storage unit 105 of the gyro sensor. The image stabilizer 100 further includes a host controller 106.

The camera lens 101 is a lens that is controlled by three-dimensional coordinates having an X axis, a Y axis orthogonal to the X axis, and a Z axis orthogonal to the X axis and the Y axis. The camera lens 101 includes an X-axis position sensor 112 (X-lens position sensor) and an X-axis actuator 113 (X-voice coil motor (VCM)). The camera lens 101 includes a Y-axis position sensor 114 (Y-lens position sensor) and a Y-axis actuator 115 (Y-VCM). The camera lens 101 includes a Z-axis position sensor 110 (Z-lens position sensor) and a Z-axis actuator 111 (Z-VCM).

The X-axis position sensor 112 and the X-axis actuator 113 are connected to the first semiconductor chip 103 and controlled by the first semiconductor chip 103. Further, the Y-axis position sensor 114 and the Y-axis actuator 115 are connected to the first semiconductor chip 103 and controlled by the first semiconductor chip 103. Further, the Z-axis position sensor 110 and the Z-axis actuator 111 are connected to the second semiconductor chip 102 and controlled by the second semiconductor chip 102.

The second semiconductor chip 102 is a primary semiconductor chip. The second semiconductor chip 102 stores Z-axis position data 107 by connection with the three-axis OIS lens 101, and controls the Z axis of the camera lens 101. The second semiconductor chip 102 is connected to the host controller by inter-integrated circuit (IIC) communication or improved inter-integrated circuit (I3C) communication.

The second semiconductor chip 102 is connected to the gyro sensor 104 via a chip select signal line, a data signal line, and a clock signal line of serial peripheral interface (SPI) communication. Further, the second semiconductor chip 102 is connected to the first semiconductor chip 103 via the chip select signal line, the data signal line, and the clock signal line of the SPI communication. Although one data line is illustrated in the drawing, two or more data lines may be actually used.

The second semiconductor chip 102 transmits the Z-axis position data 107 to the storage unit 105 of the gyro sensor via the SPI communication. The second semiconductor chip 102 reads camera shake state data and calculates a Z-axis target position of the camera lens 101.

The first semiconductor chip 103 is a secondary semiconductor chip. The first semiconductor chip 103 stores X-axis and Y-axis position data 108 by connection with the camera lens 101. Further, the first semiconductor chip 103 controls the X axis and the Y axis of the camera lens 101. The first semiconductor chip 103 is connected to the host controller by IIC communication or I3C communication.

The first semiconductor chip 103 constantly monitors SPI data. Therefore, the first semiconductor chip 103 can acquire Z-axis position data 109. The Z-axis position data 109 is acquired from the Z-axis position data stored in the storage unit 105 of the gyro sensor via the SPI communication. The first semiconductor chip 103 reads gyro data and corrects the gyro data with the Z-axis position data to calculate X-axis and Y-axis target positions of the camera lens 101.

The gyro sensor 104 acquires X-axis, Y-axis, and Z-axis gyro data as the camera shake state data. The gyro sensor 104 transmits the gyro data to the first semiconductor chip 103 and the second semiconductor chip 102 via the SPI communication. The camera shake correction is executed by the first semiconductor chip 103 and the second semiconductor chip 102 using the camera shake state data. The gyro sensor 104 includes the storage unit 105 of the gyro sensor. The storage unit 105 of the gyro sensor includes a first area and a second area. The camera shake state data is stored in the first area, and the Z-axis position data is stored in the second area.

The host controller 106 acquires the camera shake state data and the X-axis, Y-axis, and Z-axis position data from the connected second semiconductor chip 102 and first semiconductor chip 103. The host controller 106 uses the camera shake state data and the X-axis, Y-axis, and Z-axis position data for an EIS.

With such a configuration, the Z-axis position data can be transmitted and received via the SPI communication using an unused address of the gyro sensor even if there is no chip select signal line connecting the second semiconductor chip 102 and the first semiconductor chip 103.

### (Description of OIS Process According to First Embodiment)

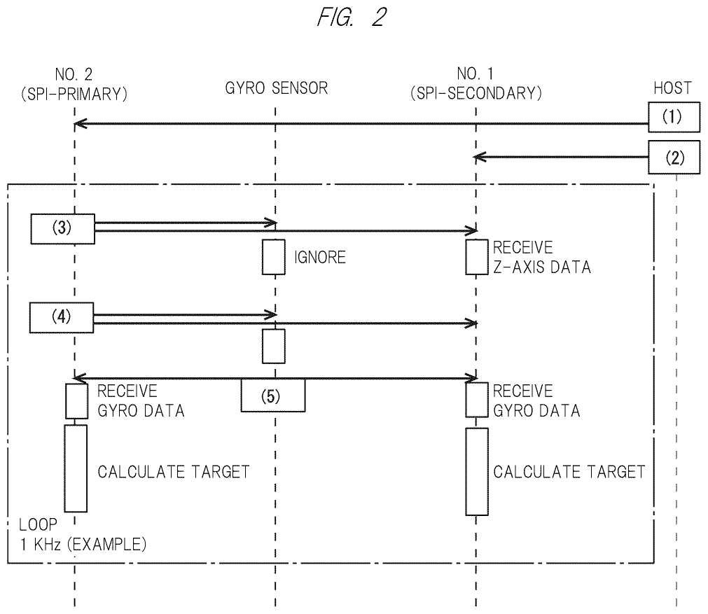

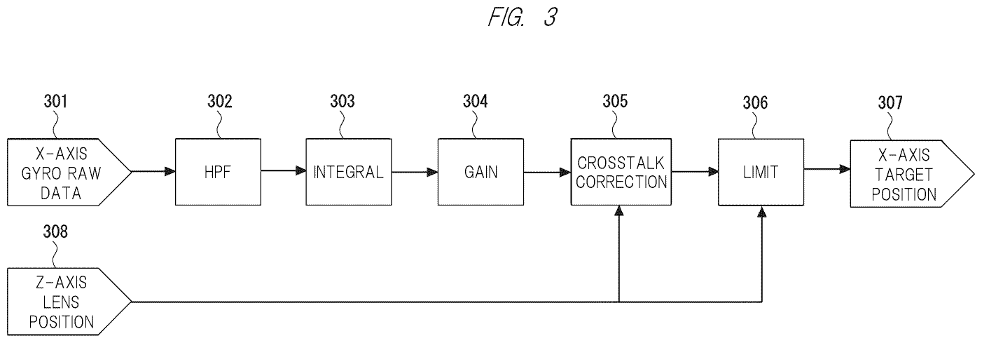

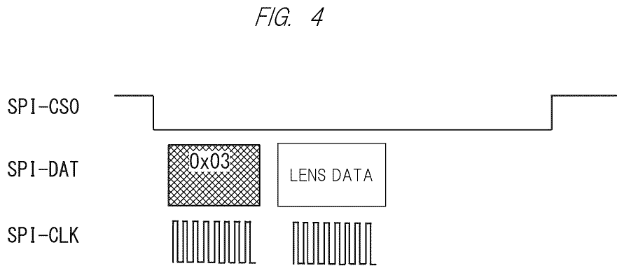

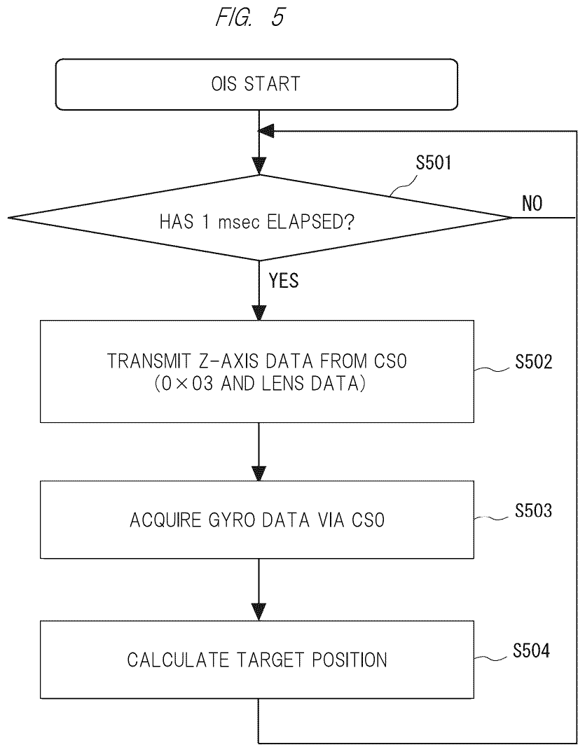

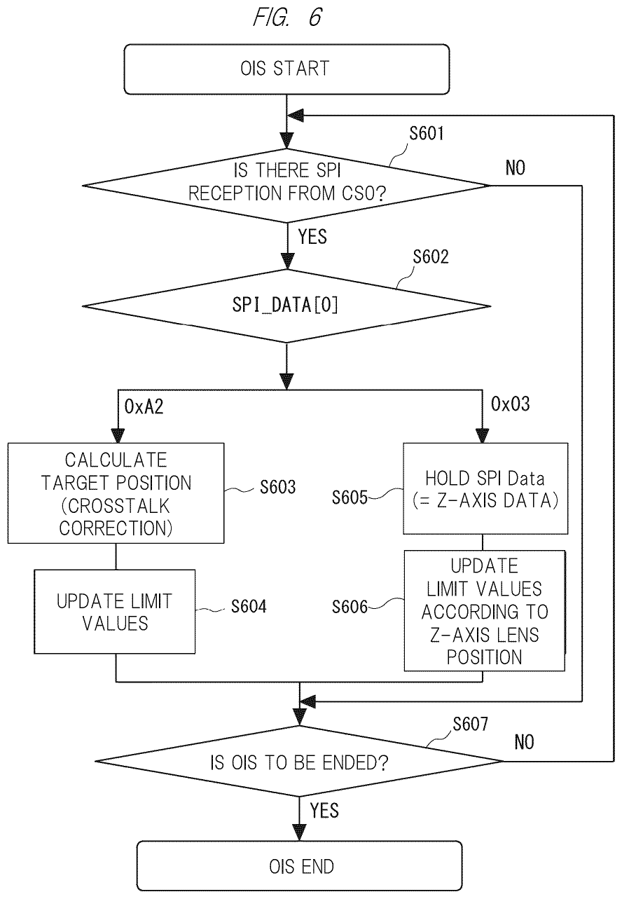

FIG. 2 is a sequence diagram of an OIS process according to the first embodiment. FIG. 3 is a block diagram illustrating an X-axis correction process using a Z-axis lens position in the OIS process according to the first embodiment. FIG. 4 is a schematic diagram illustrating an unused area of a data address of the gyro sensor in the OIS process according to the first embodiment. FIG. 5 is a flowchart illustrating an operation of the primary semiconductor chip of the two-axis OIS-IC in the OIS process according to the first embodiment. FIG. 6 is a flowchart illustrating an operation of the secondary semiconductor chip of the two-axis OIS-IC in the OIS process according to the first embodiment. The OIS process according to the first embodiment will be described with reference to FIGS. 2 to 6.

As illustrated in FIG. 2, the image stabilizer 100 operates in the following sequence.

(1) The host controller 106 transmits a start command to the second semiconductor chip 102.

(2) The host controller 106 transmits a start command to the first semiconductor chip 103.

(3) The second semiconductor chip 102 outputs a Z-axis lens position to an SPI line. At this time, an unused address and the Z-axis lens position are output. The gyro sensor 104 performs no operation (NOP) due to the unused address. The first semiconductor chip 103 recognizes an address being an identification (ID) of the Z axis as information of the Z-axis lens position. The first semiconductor chip 103 uses the information of the Z-axis lens position to calculate a target position.

(4) The second semiconductor chip 102 outputs a drive command for the gyro sensor 104 to the SPI line. The drive command is an ID of the gyro sensor. The gyro sensor 104 recognizes the ID of the gyro sensor. The first semiconductor chip 103 recognizes the ID of the gyro sensor.

(5) The gyro sensor 104 outputs gyro data to the SPI line. The first semiconductor chip 103 calculates X-axis and Y-axis target positions. The second semiconductor chip 102 calculates a Z-axis target position.

As illustrated in FIG. 3, in the calculation of the target position of the first semiconductor chip in (5) of the sequence, the Z-axis lens position is used for the X-axis correction process. Although the X axis is taken as an example here, the same applies to the Y axis.

Raw data 301 of the gyro sensor of the X axis is subjected to crosstalk correction using a Z-axis lens position 308 and correction of limit values, whereby an X-axis target position is calculated.

In the case of an actuator in which an X-axis lens position is shifted depending on a Z-axis lens position, the following crosstalk correction is required.

$$X ’ = Calculation result of X + ( Z - axis lens position - Center of Z axis ) \times Coefficient 1$$

In the case of an actuator in which X-axis and Y-axis limit lens positions are shifted depending on a Z-axis lens position, it is necessary to correct limit values as follows.

$$Max = Normal Limit Max + Z - axis lens position \times Coefficient 0$$

$$Min = Normal Limit Min + Z - axis lens position \times Coefficient 0$$

As illustrated in FIG. 4, the Z-axis lens position is output to the SPI line of the second semiconductor chip 102 in (3) of the sequence. For example, an address as an unused address of 0x03, and data of the Z-axis lens position are transmitted to an SPI data signal line in the state of being included an SPI clock after the start of communication via an SPI chip select signal line. Note that the unused area is a portion of an area of the storage unit 105 of the gyro sensor, and indicates an area not designed to store data related to an operation of the gyro sensor, such as command data, program data, and data indicating a status. Therefore, even if data is stored in the unused area, the gyro sensor does not change the operation based on the data. The unused area is also referred to as “reserved area”. The unused address indicates an address included in the unused area.

As illustrated in FIG. 5, the second semiconductor chip 102 operates as follows. Here, the OIS process is operated at 1 KHz. First, it is determined whether 1 msec has elapsed from the start of the OIS (step S501). In a case where 1 msec has not elapsed (NO in step S501), the process returns to the start of the OIS. In a case where 1 msec has elapsed (YES in step S501), the second semiconductor chip 102 transmits Z-axis lens position data from a chip select signal line 0 (CS (Chip Select) 0) (step S502). The Z-axis lens position data includes the unused address of 0x03 and data of a Z-axis lens position. Next, the second semiconductor chip 102 acquires data of the gyro sensor 104 via the chip select signal line 0 (step S503). Finally, the second semiconductor chip 102 calculates a Z-axis target position (step S504). Then, steps S501 to S504 are repeated while the OIS is operating.

As illustrated in FIG. 6, the first semiconductor chip 103 operates as follows. First, it is determined whether the first semiconductor chip 103 has received a signal from the chip select signal line 0 (step S601). In a case where no signal is received (NO in step S601), it is determined whether to end the OIS process (step S607). In a case where a signal has been received (YES in step S601), it is determined whether an address is the unused address of the gyro sensor (step S602). In a case where the address is not the unused address and, for example, is 0 xA2 which is a first address, a target position (including crosstalk correction) illustrated in FIG. 3 is calculated (step S603). Next, limit values are updated (step S604). In a case where the address is the unused address and, for example, is 0x03 which is a second address, it is recognized as the Z-axis lens position data, and the Z-axis lens position data is held (step S605). Next, the limit values according to the Z-axis lens position are updated (step S606). After step S604 and step S606, it is determined whether to end the OIS process (step S607). In a case where the OIS process is to be ended (YES in step S607), the OIS process is ended. In a case where the OIS process is not to be ended (NO in step S607), the process returns to the start of the OIS process (step S601).

In this manner, the Z-axis position data can be transmitted and received via the SPI communication using the unused address of the gyro sensor even if there is no chip select signal line connecting the second semiconductor chip 102 and the first semiconductor chip 103.

### (Description of OIS Process According to Second Embodiment)

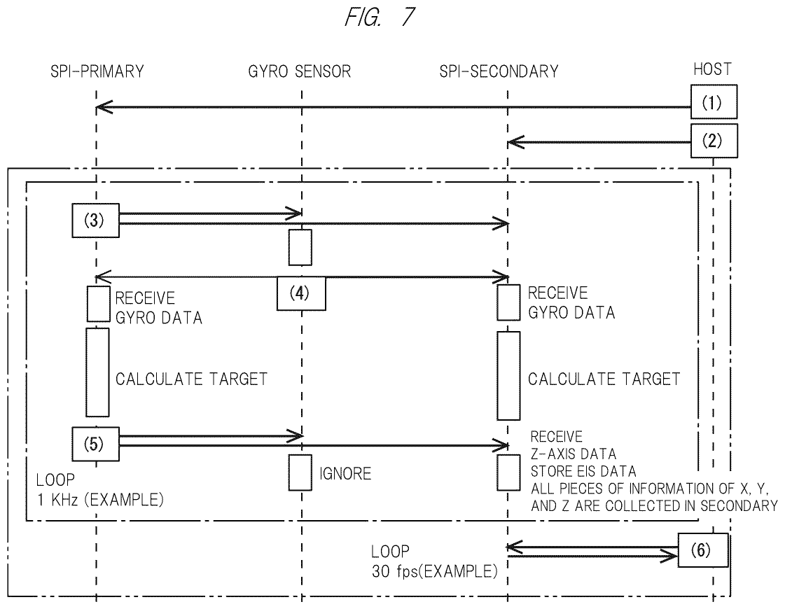

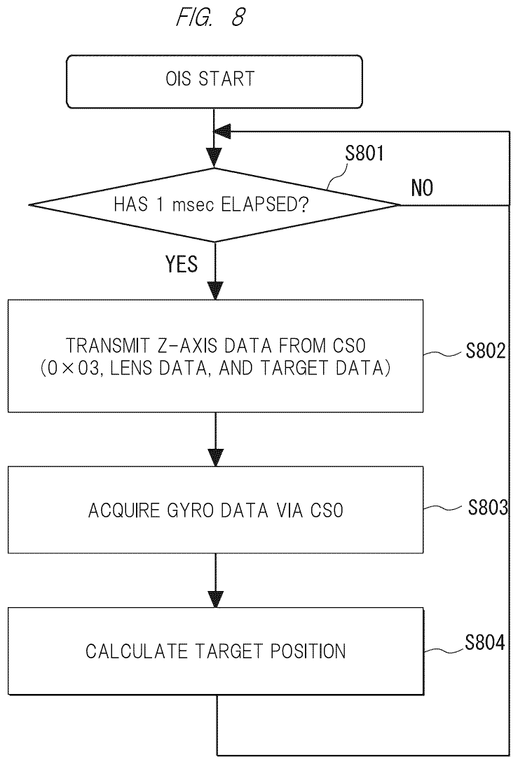

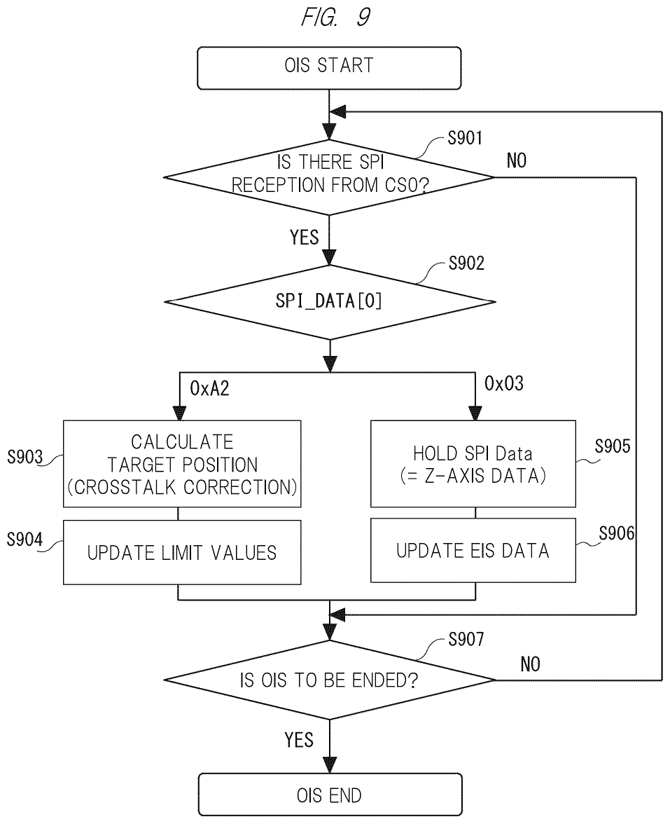

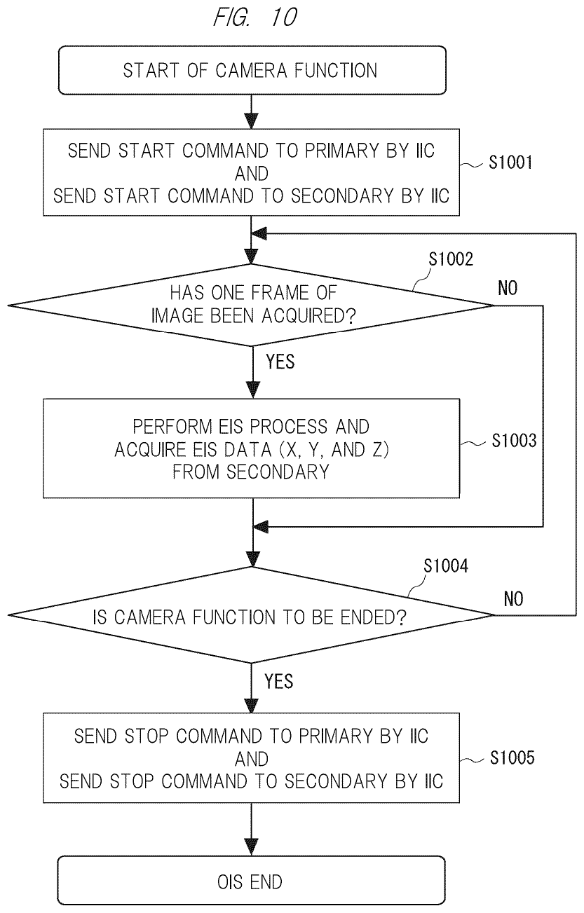

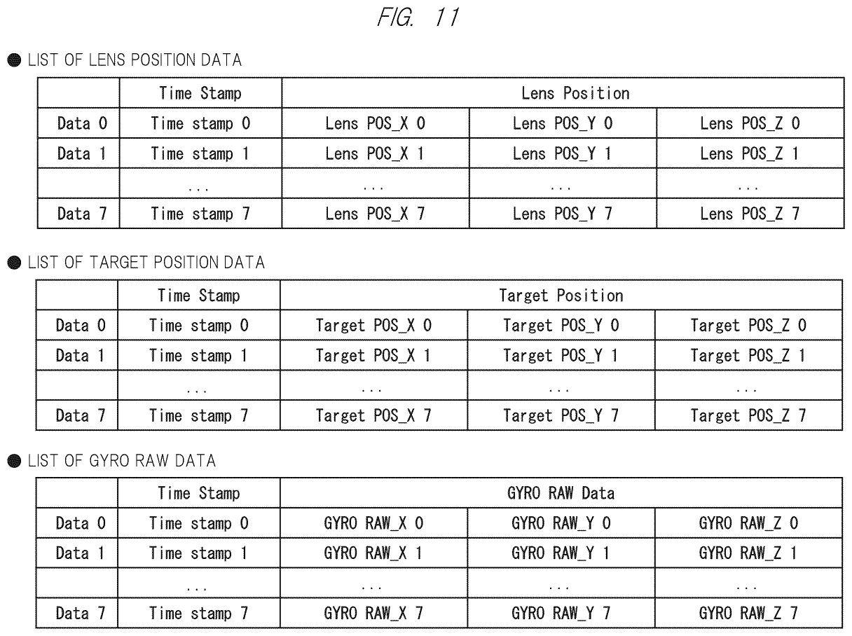

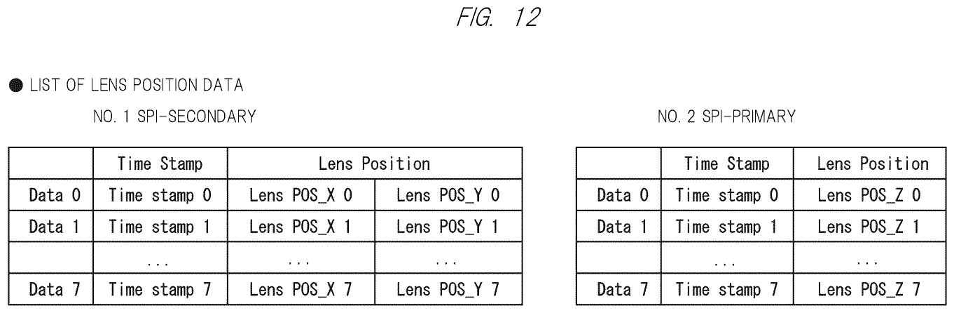

FIG. 7 is a sequence diagram of an OIS process according to a second embodiment. FIG. 8 is a flowchart illustrating an operation of a primary semiconductor chip of a two-axis OIS-IC in the OIS process according to the second embodiment. FIG. 9 is a flowchart illustrating an operation of a secondary semiconductor chip of a two-axis OIS-IC in the OIS process according to the second embodiment. FIG. 10 is a flowchart illustrating an operation of a host controller in the OIS process according to the second embodiment. FIG. 11 is a view illustrating content examples of EIS data according to the second embodiment. FIG. 12 is a view illustrating content examples of EIS data according to a related technique. The OIS process according to the second embodiment will be described with reference to FIGS. 7 to 12.

An image stabilizer according to the second embodiment has the same configuration as the image stabilizer 100 according to the first embodiment. The second embodiment is different from the first embodiment in that the host controller 106 performs an EIS process.

As illustrated in FIG. 7, the image stabilizer 100 according to the second embodiment operates in the following sequence.
(1) The host controller 106 transmits a start command to the second semiconductor chip 102.
(2) The host controller 106 transmits a start command to the first semiconductor chip 103.
(3) The second semiconductor chip 102 outputs a gyro command to an SPI line. An ID of a gyro sensor is output. The gyro sensor 104 recognizes the command as the ID of the gyro sensor. The first semiconductor chip 103 recognizes the command as the ID of the gyro sensor.
(4) The gyro sensor 104 outputs gyro data to the SPI line. The second semiconductor chip 102 calculates a Z-axis target position. The first semiconductor chip 103 calculates X-axis and Y-axis target positions.
(5) The second semiconductor chip 102 outputs a Z-axis lens position and the Z-axis target position to the SPI line. The first semiconductor chip 103 acquires the Z-axis lens position and the Z-axis target position.
(6) The host controller 106 acquires X-axis, Y-axis, and Z-axis EIS data from the first semiconductor chip 103 via IIC communication.

The second semiconductor chip 102 and the first semiconductor chip 103 transmit and receive camera shake state data, lens position data, and target position data with the gyro sensor 104 at a calculation cycle such as 1 kHz, and accumulate the EIS data. The host controller 106 reads EIS data at an image reading cycle such as 30 fps, for example, and executes the EIS process.

As illustrated in FIG. 8, the second semiconductor chip 102 operates as follows. Here, the OIS process is operated at 1 KHz. First, it is determined whether 1 msec has elapsed from the start of the OIS (step S801). In a case where 1 msec has not elapsed (NO in step S801), the process returns to the start of the OIS. In a case where 1 msec has elapsed (YES in step S801), the second semiconductor chip 102 transmits Z-axis data from the chip select signal line 0 (CS0) (step S802). The Z-axis data includes 0x03, lens position data, and target position data. Next, the second semiconductor chip 102 acquires data of the gyro sensor 104 via the chip select signal line 0 (step S803). Finally, the second semiconductor chip 102 calculates a Z-axis target position (step S804). Then, steps S801 to S804 are repeated while the OIS is operating.

As illustrated in FIG. 9, the first semiconductor chip 103 operates as follows. First, it is determined whether the first semiconductor chip 103 has received a signal from the chip select signal line 0 (step S901). In a case where no signal is received (NO in step S901), it is determined whether to end the OIS process (step S907). In a case where a signal has been received (YES in step S901), it is determined whether an address is an unused address of the gyro sensor (step S902). In a case where the address is not the unused address and, for example, is 0 xA2 which is a first address, a target position (including crosstalk correction) illustrated in FIG. 3 is calculated (step S903). Next, limit values are updated (step S904). In a case where the address is the unused address and, for example, is 0x03 which is a second address, it is recognized as the Z-axis data, and the Z-axis data is held (step S905). Next, EIS data according to Z-axis lens position and target position is updated (step S906). After step S904 and step S906, it is determined whether to end the OIS process (step S907). In a case where the OIS process is to be ended (YES in step S907), the OIS process is ended. In a case where the OIS process is not to be ended (NO in step S907), the process returns to the start of the OIS process (step S901).

As illustrated in FIG. 10, the host controller 106 operates as follows. First, the host controller 106 transmits a start command to the second semiconductor chip 102, which is the primary, via IIC communication. Further, the host controller 106 transmits a start command to the first semiconductor chip 103, which is the secondary, via IIC communication (step S1001). Next, the host controller 106 determines whether one frame of image has been acquired (step S1002). In a case where one frame has been acquired (in the case of YES in step S1002), the EIS process is performed (step S1003). The host controller 106 acquires the X-axis, Y-axis, and Z-axis EIS data from the first semiconductor chip 103. In a case where one frame has not been acquired (in the case of NO in step S1002) and step S1003 is ended, the host controller 106 determines whether to end a camera function (step S1004). In a case where the camera function is not to be ended (NO in step S1004), the process returns to step S1002. In a case where the camera function is to be ended (YES in step S1004), the host controller 106 transmits a stop command to the second semiconductor chip 102, which is the primary, via the IIC communication. Further, the host controller 106 transmits a stop command to the first semiconductor chip 103, which is the secondary, via the IIC communication (step S1005). Finally, the host controller 106 ends the OIS process.

As illustrated in FIG. 11, in a case where an image is acquired at 30 fps, a capturing time per frame is 33.3 milliseconds. In a case where data such as a lens position is acquired once every 4 milliseconds, the number of pieces of data per frame is about 8. Three types of lens position data, target position data, and gyro raw data are acquired. As illustrated in FIG. 12, in a case where an image is similarly acquired at 30 fps, lens position data is generated for each of the first semiconductor chip 103 and the second semiconductor chip 102. In addition to a table of FIG. 12, target position data and gyro raw data are also similarly generated.

Therefore, the number of pieces of data in the second embodiment is 3×4×8=96, and the number of pieces of data in the related technique is 3×3×8+3×2×8=120. Therefore, the second embodiment can reduce the number of pieces of data. A communication time theoretical value at 1 Mbps can be shortened from 2.22 msec to 1.76 msec. Further, there is a case where a timing at which data is acquired differs between two systems of the IIC communication, and the EIS process becomes difficult. In a method of the second embodiment, pieces of data of all the axes are accurately synchronized.

Since pieces of data of all the axes can be acquired from one semiconductor chip in this manner, the amount of data communication of the EIS can be reduced.

### (Description of OIS Process According to Third Embodiment)

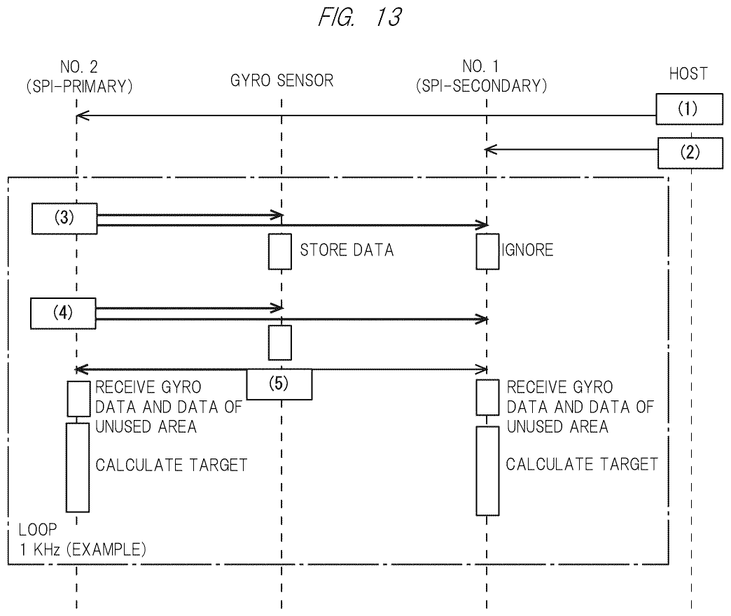

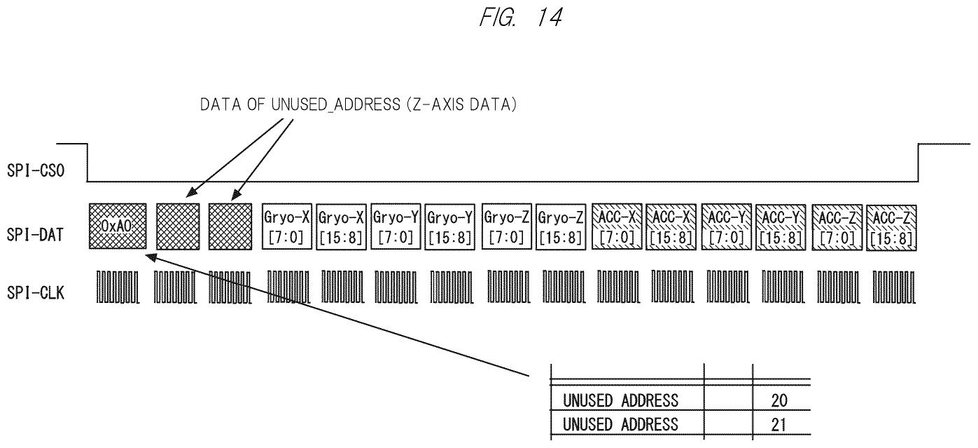

FIG. 13 is a sequence diagram of an OIS process according to a third embodiment. FIG. 14 is a schematic diagram illustrating an unused area of a data address of a gyro sensor in the OIS process according to the third embodiment. The OIS process according to the third embodiment will be described with reference to FIGS. 13 and 14.

An image stabilizer according to the third embodiment has the same configuration as the image stabilizer 100 according to the first embodiment. The OIS process according to the third embodiment is different from the OIS process according to the first embodiment in that the gyro sensor 104 simultaneously transmits Z-axis position data and gyro data to the first semiconductor chip 103.

As illustrated in FIG. 13, the image stabilizer 100 operates in the following sequence.
(1) The host controller 106 transmits a start command to the second semiconductor chip 102.
(2) The host controller 106 transmits a start command to the first semiconductor chip 103.
(3) The second semiconductor chip 102 outputs a Z-axis lens position to an SPI line. At this time, an unused address and the Z-axis lens position are output. The gyro sensor 104 stores data due to the unused address. The first semiconductor chip 103 ignores the data from the second semiconductor chip 102.
(4) The second semiconductor chip 102 outputs an address of the unused address to the SPI line.
(5) The gyro sensor 104 outputs data of the unused address and data of the gyro sensor. The first semiconductor chip 103 recognizes the data of the unused address and the data of the gyro sensor. The first semiconductor chip 103 calculates target positions on the basis of these pieces of data. The second semiconductor chip 102 calculates a Z-axis target position.

As illustrated in FIG. 14, a second area as the unused area and a first area in which camera shake state data is stored are continuous in the storage unit 105 of the gyro sensor. The first semiconductor chip 103 sends address (0x20)+(0x80) of the unused area to the SPI line in order to acquire the gyro data and data of the unused area from the gyro sensor 104. Then, the first semiconductor chip 103 can acquire Z-axis lens position data of the unused address and the gyro data.

In this manner, it is possible to not only transmit and receive the Z-axis position data by SPI communication using the unused address of the gyro sensor, but also reduce the number of times of communication.

### (Description of Image Stabilizer According to Fourth Embodiment)

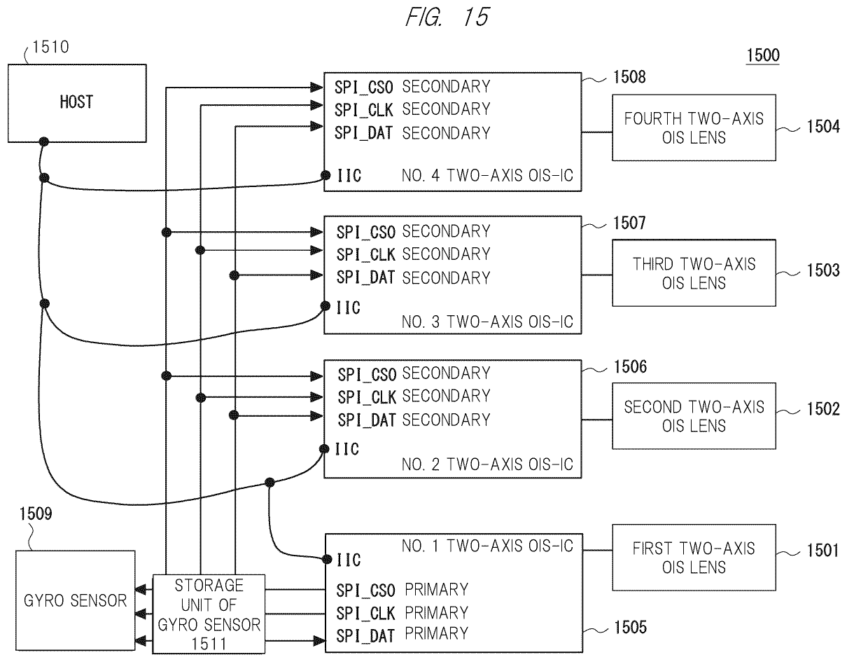

FIG. 15 is a block diagram illustrating a configuration of an image stabilizer, which controls a plurality of two-axis OIS-ICs and two-axis OIS lenses respectively connected to the two-axis OIS-ICs, according to a fourth embodiment. The image stabilizer according to the fourth embodiment will be described with reference to FIG. 15. An image stabilizer 1500 is a semiconductor device that is used in an imaging apparatus to correct a camera shake. The image stabilizer 1500 corrects a camera shake using two or more two-axis OIS-ICs and two or more two-axis OIS lenses.

The image stabilizer 1500 according to the fourth embodiment includes a first two-axis OIS lens (hereinafter, referred to as first camera lens) 1501, a second two-axis OIS lens (hereinafter, referred to as second camera lens) 1502, a No. 1 two-axis OIS-IC (hereinafter referred to as first semiconductor chip) 1505, a No. 2 two-axis OIS-IC (hereinafter, referred to as second semiconductor chip) 1506, a gyro sensor 1509, a host controller 1510, and a storage unit 1511 of the gyro sensor. Further, the image stabilizer 1500 according to the fourth embodiment may include a third two-axis OIS lens (hereinafter, referred to as third camera lens) 1503, a fourth two-axis OIS lens (hereinafter, referred to as fourth camera lens) 1504, a No. 3 two-axis OIS-IC (hereinafter, referred to as third semiconductor chip) 1507, and a No. 4 two-axis OIS-IC (hereinafter, referred to as fourth semiconductor chip) 1508.

The first camera lens 1501 is a lens that is controlled by two axes of three-dimensional coordinates including an X axis, a Y axis orthogonal to the X axis, and a Z axis orthogonal to the X axis and the Y axis. The first camera lens 1501 includes position sensors of the two axes and actuators of the two axes. The position sensors of the two axes and the actuators of the two axes among the three axes are connected to the first semiconductor chip 1505 and controlled by the first semiconductor chip 1505.

The first semiconductor chip 1505 is a primary semiconductor chip. The first semiconductor chip 1505 is connected to the second semiconductor chip 1506 via a chip select signal line, a data signal line, and a clock signal line of SPI communication. Further, the first semiconductor chip 1505 is connected to the gyro sensor 1509 via the chip select signal line, the data signal line, and the clock signal line of the SPI communication. The first semiconductor chip 1505 is connected to the host controller 1510 via IIC communication.

The first semiconductor chip 1505 receives a command by connection with the host controller 1510. The first semiconductor chip 1505 transmits the command from the host controller to the storage unit 1511 of the gyro sensor via the SPI communication.

The second camera lens 1502 is a lens that is controlled by two axes of the three-dimensional coordinates including the X axis, the Y axis orthogonal to the X axis, and the Z axis orthogonal to the X axis and the Y axis. Position sensors of the two axes and actuators of the two axes among the three axes are connected to the second semiconductor chip 1506 and controlled by the second semiconductor chip 1506.

The second semiconductor chip 1506 is a secondary semiconductor chip. The second semiconductor chip 1506 is connected to the gyro sensor 1509 via a chip select signal line, a data signal line, and a clock signal line of SPI communication. Further, the second semiconductor chip 1506 is connected to the first semiconductor chip 1505 via the chip select signal line, the data signal line, and the clock signal line of the SPI communication. The second semiconductor chip 1506 is connected to the host controller 1510 by IIC communication.

Further, the second semiconductor chip 1506 constantly monitors SPI data. In a case where an address of the SPI data is an address of the gyro, it is recognized as gyro data and used to calculate a target position. In the case of an unused address indicating command information, it is used as a command. That is, the number of commands transmitted by the host controller 1510 to the plurality of semiconductor chips is one.

The gyro sensor 1509 acquires X-axis, Y-axis, and Z-axis gyro data as camera shake state data. The gyro sensor 1509 transmits the gyro data to the first semiconductor chip 1505 and the second semiconductor chip 1506 via SPI communication. The gyro sensor 1509 may transmit the gyro data to the host controller 1510 via the SPI communication as in a fifth embodiment.

Since the third camera lens 1503 and the fourth camera lens 1504 have the same configuration as that of the second camera lens 1502, the description thereof is omitted. Since the third semiconductor chip 1507 and the fourth semiconductor chip 1508 have the same configuration as that of the second semiconductor chip 1506, the description thereof is omitted. As described above, one of the plurality of semiconductor chips is connected to one of the plurality of camera lenses. There is no limitation on the number of sets of the third camera lens 1503 and the third semiconductor chip 1507 and the number of sets of the fourth camera lens 1504 and the fourth semiconductor chip 1508.

With such a configuration, the host controller can command the plurality of semiconductor chips by transmitting the command once. Therefore, a command transmission time is shortened.

### (Description of OIS Process According to Fourth Embodiment)

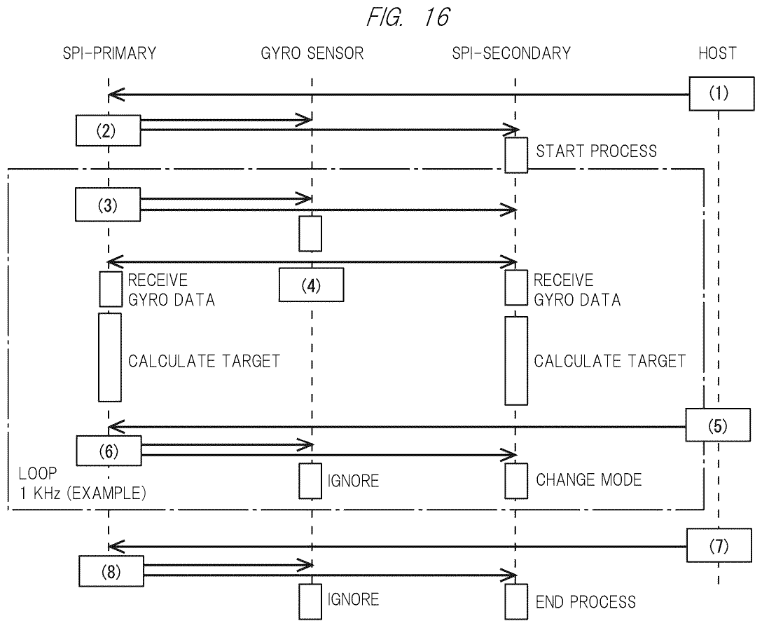

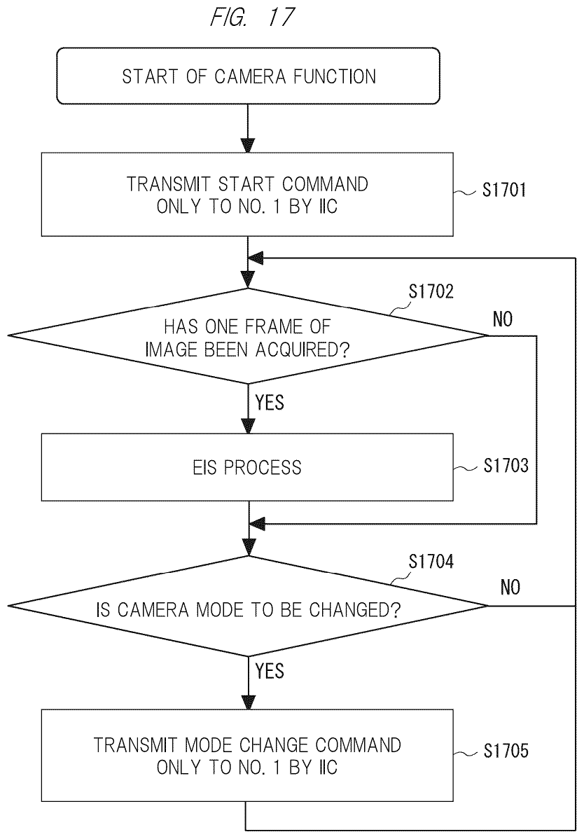

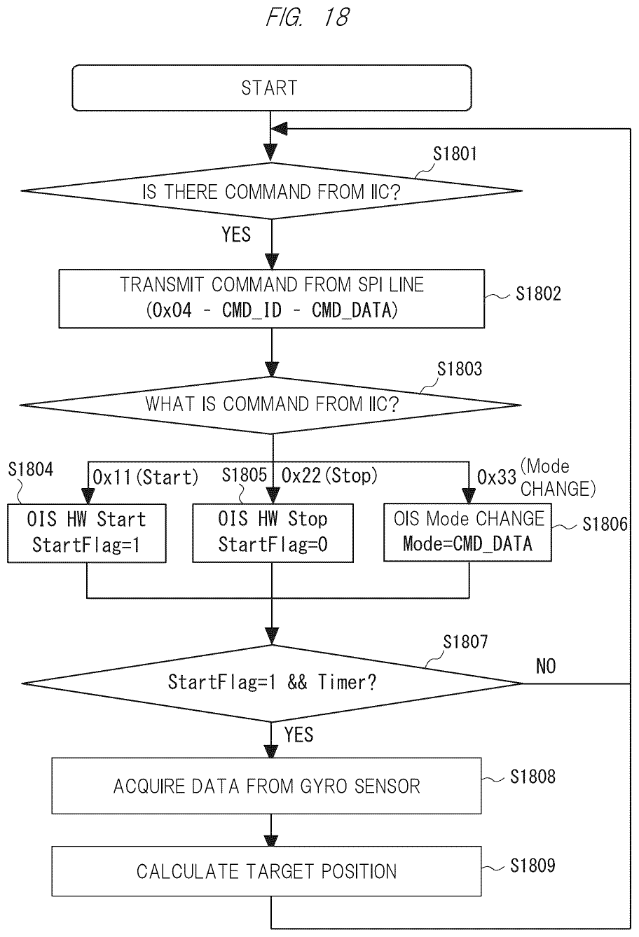

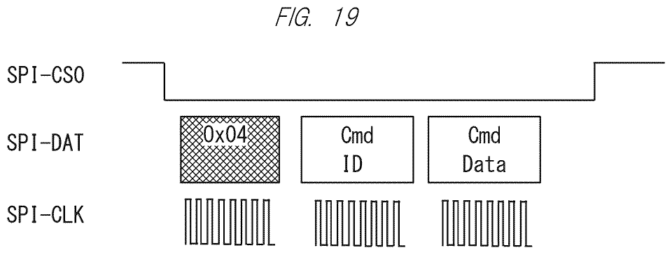

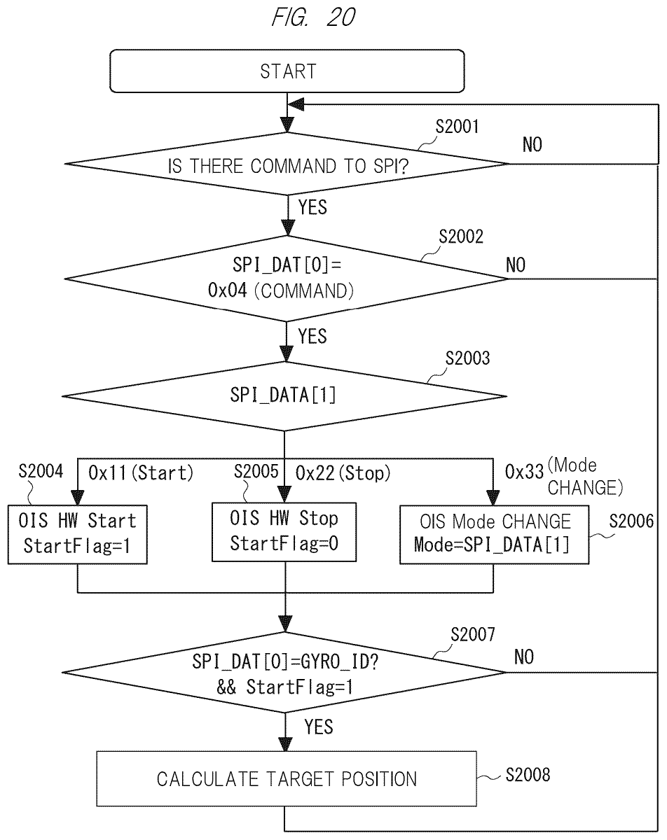

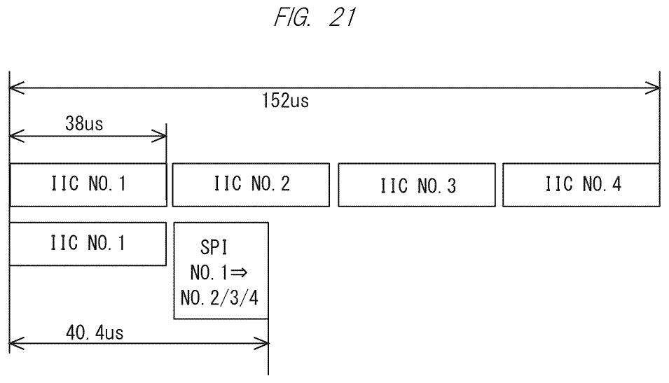

FIG. 16 is a sequence diagram of an OIS process according to the fourth embodiment. FIG. 17 is a flowchart illustrating an operation of the primary semiconductor chip of the two-axis OIS-IC in the OIS process according to the fourth embodiment. FIG. 18 is a flowchart illustrating an operation of the secondary semiconductor chip of the two-axis OIS-IC in the OIS process according to the fourth embodiment. FIG. 19 is a schematic diagram illustrating an unused area of a data address of the gyro sensor in the OIS process according to the fourth embodiment. FIG. 20 is a flowchart illustrating an operation of the host controller in the OIS process according to the fourth embodiment. FIG. 21 is a diagram illustrating a time required for the OIS process according to the fourth embodiment and a time required for an OIS process according to a related technique. The OIS process according to the fourth embodiment will be described with reference to FIGS. 16 to 21.

As illustrated in FIG. 16, the image stabilizer 1500 operates in the following sequence.
(1) The host controller 1510 transmits a start command to the first semiconductor chip 1505.
(2) The first semiconductor chip 1505 transmits the start command to an unused area of the storage unit 1511 of the gyro sensor via SPI communication. The second semiconductor chip 1506, the third semiconductor chip 1507, and the fourth semiconductor chip 1508 monitor the SPI communication and receive the start command. Each of the second semiconductor chip 1506, the third semiconductor chip 1507, and the fourth semiconductor chip 1508 starts the process. The gyro sensor does not operate due to an address of the unused area.
(3) The first semiconductor chip 1505 outputs a drive command of the gyro sensor 1509 to an SPI line. The drive command is an ID of the gyro sensor. The gyro sensor 1509 recognizes the command as the ID of the gyro sensor. The second semiconductor chip 1506, the third semiconductor chip 1507, and the fourth semiconductor chip 1508 recognize the command as the ID of the gyro sensor.
(4) The gyro sensor 1509 outputs data of the gyro sensor 1509 to the SPI line. The first semiconductor chip 1505 acquires the gyro data and calculates target positions of the two axes. The second semiconductor chip 1506 acquires the gyro data and calculates target positions of the two axes. The third semiconductor chip 1507 acquires the gyro data and calculates target positions of the two axes. The fourth semiconductor chip 1508 acquires the gyro data and calculates target positions of the two axes.
(5) The host controller 1510 transmits a mode change command such as changing a capturing condition to the first semiconductor chip 1505.
(6) The first semiconductor chip 1505 transmits the mode change command to the unused area of the storage unit 1511 of the gyro sensor via the SPI communication. The second semiconductor chip 1506, the third semiconductor chip 1507, and the fourth semiconductor chip 1508 monitor the SPI communication and receive the mode change command. Each of the second semiconductor chip 1506, the third semiconductor chip 1507, and the fourth semiconductor chip 1508 changes a mode. The gyro sensor does not operate due to an address of the unused area.
(7) The host controller 1510 transmits a stop command to the first semiconductor chip 1505.
(8) The first semiconductor chip 1505 transmits the stop command to the unused area of the storage unit 1511 of the gyro sensor via the SPI communication. The second semiconductor chip 1506, the third semiconductor chip 1507, and the fourth semiconductor chip 1508 monitor the SPI communication and receive the stop command. Each of the second semiconductor chip 1506, the third semiconductor chip 1507, and the fourth semiconductor chip 1508 stops the process. The gyro sensor does not operate due to an address of the unused area.

As illustrated in FIG. 17, the host controller 1510 operates as follows. First, a camera function is started, and the start command is transmitted only to the first semiconductor chip 1505 by IIC communication (step S1701). Next, it is determined whether the host controller 1510 has acquired one frame of image (step S1702). In a case where one frame has been acquired (in the case of YES in step S1702), the host controller 1510 executes an EIS process (step S1703). In a case where one frame has not been acquired (in the case of NO in step S1702) and after the EIS process is executed (step S1703), the host controller 1510 determines whether to change a camera mode (step S1704). In a case where the camera mode is to be changed (in the case of YES in step S1704), the host controller 1510 transmits the mode change command only to the first semiconductor chip 1505 by the IIC communication (step S1705). In a case where no change is made (NO in step S1704) and after the mode change command is transmitted (step S1705), the process returns to step S1702.

As illustrated in FIG. 18, the first semiconductor chip 1505 operates as follows. First, it is determined whether a command has been transmitted from an IIC (step S1801). In a case where no command is transmitted (NO in step S1801), the first semiconductor chip 1505 stands by. In a case where a command has been transmitted (YES in step S1801), the first semiconductor chip 1505 transmits the command from the SPI line (step S1802). As illustrated in FIG. 19, the command includes, for example, an address 0x04 which is an unused area of the gyro sensor, a command ID, and command data. Next, the first semiconductor chip 1505 determines what the command from the IIC is (step S1803). In a case where the command ID is 0x11, hardware (HW) of the OIS is started, and a start flag is set to 1 (step S1804). In a case where the command ID is 0x22, the HW of the OIS is stopped, and the start flag is set to 0 (step S1805). In a case where the command ID is 0x33, an OIS mode is changed, and the command data is input to the mode (step S1806). Next, it is determined whether the start flag is 1 and a time has elapsed (step S1807). In a case where the start flag is 1 and the time has elapsed, the first semiconductor chip 1505 acquires data from the gyro sensor 1509 (step S1808). Finally, the first semiconductor chip 1505 calculates target positions of the two axes (step S1809). In a case where the start flag is not 1 or the time has not elapsed (NO in step S1807) and after the target positions are calculated (step S1809), the process returns to step S1801, and steps S1801 to S1809 are repeated while the OIS is operating.

As illustrated in FIG. 20, the second semiconductor chip 1506 operates as follows. First, it is determined whether a command has been transmitted to the SPI line (step S2001). In a case where no command has been transmitted (NO in step S2001), the second semiconductor chip 1506 stands by. In a case where the command has been transmitted (YES in step S2001), the second semiconductor chip 1506 determines whether SPI data indicates a command at, for example, an address 0x04 (step S2002). In a case where the SPI data does not indicate the command (NO in step S2002), the process returns to step S2001. In a case where the SPI data indicates the command (YES in step S2002), the second semiconductor chip 1506 determines what Command data 1 is (step S2003). In a case where a command ID is 0x11, hardware (HW) of the OIS is started, and a start flag is set to 1 (step S2004). In a case where the command ID is 0x22, the HW of the OIS is stopped, and the start flag is set to 0 (step S2005). In a case where the command ID is 0x33, an OIS mode is changed, and the command data is input to the mode (step S2006). Next, it is determined whether SPI data 0 is a gyro ID and the start flag is 1 (step S2007). In a case where the SPI data 0 is the gyro ID and the start flag is 1, the second semiconductor chip 1506 calculates target positions of the two axes (step S2008). In a case where the SPI data 0 is not the gyro ID or the start flag is not 1 (NO in step S2007) and after the target positions are calculated (step S2008), the process returns to step S2001, and steps S2001 to S2008 are repeated while the OIS is operating.

In this manner, a time for the host controller 1510 to send a command to one semiconductor chip by the IIC is set to 38 μs as illustrated in FIG. 21. In a case where the host controller 1510 transmits the command to the four semiconductor chips, 152 μs is required in the related technique, but this can be shortened to 40.4 μs by a method of the present disclosure.

### (Description of OIS Process According to Fifth Embodiment)

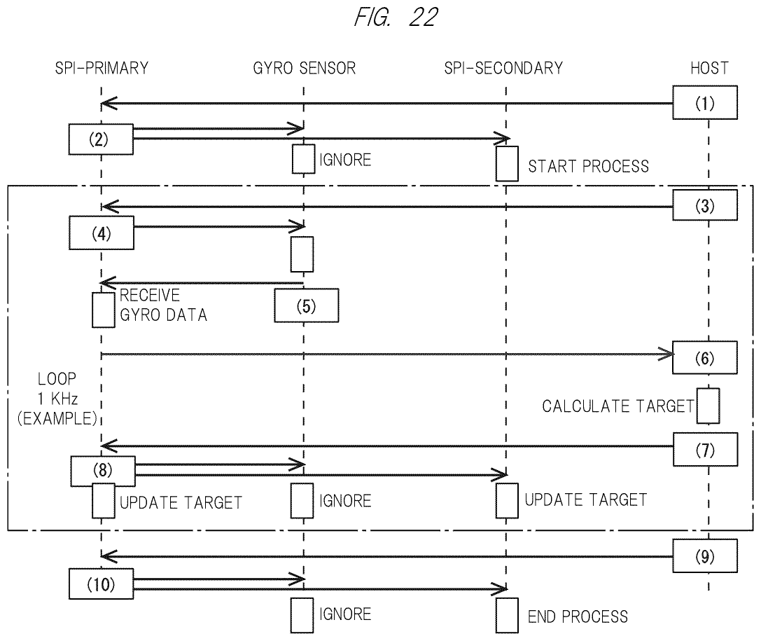

FIG. 22 is a sequence diagram of an OIS process according to the fifth embodiment. The OIS process according to the fifth embodiment will be described with reference to FIG. 22.

An image stabilizer according to the fifth embodiment has the same configuration as the image stabilizer 1500 according to the fourth embodiment. The OIS process according to the fifth embodiment is different from the OIS process according to the fourth embodiment in that the host controller 1510 calculates a target position.

As illustrated in FIG. 22, the image stabilizer 1500 operates in the following sequence.
(1) The host controller 1510 transmits a start command to the first semiconductor chip 1505.
(2) The first semiconductor chip 1505 transmits the start command to an unused area of the storage unit 1511 of the gyro sensor via SPI communication. The second semiconductor chip 1506, the third semiconductor chip 1507, and the fourth semiconductor chip 1508 monitor the SPI communication and receive the start command. Each of the second semiconductor chip 1506, the third semiconductor chip 1507, and the fourth semiconductor chip 1508 starts the process. The gyro sensor does not operate due to an address of the unused area.
(3) The host controller 1510 transmits a gyro read command to the first semiconductor chip 1505.
(4) The first semiconductor chip 1505 transmits the read command to the gyro sensor 1509 via the SPI communication.
(5) The first semiconductor chip 1505 reads data from the gyro sensor 1509 via the SPI communication.
(6) The host controller 1510 acquires gyro data from the first semiconductor chip 1505 by IIC communication. The host controller 1510 calculates target positions of the respective lenses.
(7) The host controller 1510 transmits the target positions of the respective lenses to the first semiconductor chip 1505.
(8) The first semiconductor chip 1505 transmits a target update command to the second semiconductor chip 1506, the third semiconductor chip 1507, and the fourth semiconductor chip 1508 using the unused area of the storage unit 1511 of the gyro sensor. The first semiconductor chip 1505, the second semiconductor chip 1506, the third semiconductor chip 1507, and the fourth semiconductor chip 1508 control positions of the connected lenses, respectively.
(9) The host controller 1510 transmits a stop command to the first semiconductor chip 1505.
(10) The first semiconductor chip 1505 transmits the stop command to the unused area of the storage unit 1511 of the gyro sensor via the SPI communication. The second semiconductor chip 1506, the third semiconductor chip 1507, and the fourth semiconductor chip 1508 monitor the SPI communication and receive the stop command. Each of the second semiconductor chip 1506, the third semiconductor chip 1507, and the fourth semiconductor chip 1508 stops the process. The gyro sensor does not operate due to an address of the unused area.

In this manner, the first semiconductor chip 1505, the second semiconductor chip 1506, the third semiconductor chip 1507, and the fourth semiconductor chip 1508 can be configured not to calculate the target positions. The host controller 1510 can transmit the target positions only to the first semiconductor chip 1505 at a high speed.

In the first semiconductor chip 103, the second semiconductor chip 102, the first semiconductor chip 1505, the second semiconductor chip 1506, the third semiconductor chip 1507, and the fourth semiconductor chip 1508 described above, processing is executed using a program. In the host controller 106 and the host controller 1510, processing is executed using the program. The program can be stored using various types of non-transitory computer readable media and supplied to a computer. The non-transitory computer-readable media include various types of tangible storage media. Examples of the non-transitory computer readable media include magnetic recording media (for example, a flexible disk, a magnetic tape, and a hard disk drive), a magneto-optical recording medium (for example, a magneto-optical disk), a CD-ROM (read only memory), CD-R, a CD-R/W, and semiconductor memories (for example, a mask ROM, a programmable ROM (PROM), an erasable PROM (EPROM), a flash ROM, and a random access memory (RAM)). Further, the program may be supplied to the computer using various types of transitory computer readable media. Examples of the transitory computer-readable media include an electrical signal, an optical signal, and an electromagnetic wave. The transitory computer-readable media can supply the program to the computer via a wired communication path such as an electric wire and an optical fiber or a wireless communication path.

As above, certain aspects of the invention that has been made by the inventor have been described in detail based on the embodiments, the invention is not limited to the above-described embodiments, and it is obvious that various types of modifications can be made in the range of not departing from a gist thereof.

What is claimed is:

1. A semiconductor device comprising:
a camera lens configured to control an X axis, a Y axis orthogonal to the X axis, and a Z axis orthogonal to the X axis and the Y axis to perform camera shake correction;
a first semiconductor chip configured to receive data of the X axis and the Y axis of the camera lens;
a second semiconductor chip configured to receive data of the Z axis of the camera lens; and
a gyro sensor configured to acquire camera shake state data,
wherein the second semiconductor chip is connected to the first semiconductor chip via a chip select signal line, a data signal line, and a clock signal line of serial peripheral interface (SPI) communication,
wherein the second semiconductor chip is connected to the gyro sensor via the chip select signal line, the data signal line, and the clock signal line of the SPI communication, and
wherein the second semiconductor chip transmits position data of the Z axis to a storage unit of the gyro sensor via the SPI communication.

2. The semiconductor device according to claim 1,
wherein the storage unit of the gyro sensor includes a first area and a second area,
wherein the camera shake state data is stored in the first area, and
wherein the position data of the Z axis is stored in the second area.

3. The semiconductor device according to claim 1,
wherein the second semiconductor chip is a primary, and
wherein the first semiconductor chip is a secondary.

4. The semiconductor device according to claim 1,
wherein the first semiconductor chip is connected to a host controller, and
wherein the second semiconductor chip is connected to a host controller.

5. The semiconductor device according to claim 2, wherein the first semiconductor chip reads the position data of the Z axis in the second area and performs a correction process.

6. The semiconductor device according to claim 1,
wherein the first semiconductor chip reads the camera shake state data and calculates target positions of the camera lens on the X axis and the Y axis,
and
wherein the second semiconductor chip reads the camera shake state data and calculates a target position of the camera lens on the Z axis.

7. The semiconductor device according to claim 2,
wherein the second semiconductor chip reads the camera shake state data, calculates a target position of the camera lens on the Z axis, and outputs the target position of the camera lens on the Z axis to the second area, and
wherein the first semiconductor chip reads the position data of the Z axis and the target position of the camera lens on the Z axis in the second area and stores electronic image stabilizer (EIS) data.

8. The semiconductor device according to claim 2, wherein the first area is continuous after the second area.

9. A semiconductor device comprising:
a first camera lens configured to control two axes among three axes of an X axis, a Y axis orthogonal to the X axis, and a Z axis orthogonal to the X axis and the Y axis;
a second camera lens configured to control two axes among the three axes of the X axis, the Y axis, and the Z axis;
a first semiconductor chip configured to control the first camera lens;
a second semiconductor chip configured to control the second camera lens; and
a gyro sensor configured to acquire camera shake state data,
wherein the first camera lens and the second camera lens are used for camera shake correction,
wherein the first semiconductor chip is connected to the second semiconductor chip via a chip select signal line, a data signal line, and a clock signal line of SPI communication,
wherein the first semiconductor chip is connected to the gyro sensor via the chip select signal line, the data signal line, and the clock signal line of the SPI communication,
wherein the first semiconductor chip is connected to a host controller via inter-integrated circuit (IIC) communication, and
wherein the first semiconductor chip transmits a command from the host controller to a storage unit of the gyro sensor via the SPI communication.

10. The semiconductor device according to claim 9,
wherein the storage unit of the gyro sensor includes a first area and a second area,
wherein the camera shake state data is stored in the first area, and
wherein the command from the host controller is stored in the second area.

11. The semiconductor device according to claim 9, wherein the second semiconductor chip receives the command of the host controller from the first semiconductor chip via the SPI communication.

12. The semiconductor device according to claim 9, comprising:
a plurality of the second semiconductor chips; and
a plurality of the second camera lenses,
wherein one of the plurality of second semiconductor chips is connected to one of the plurality of second camera lenses.

13. The semiconductor device according to claim 9, wherein the second semiconductor chip acquires the camera shake state data and calculates a target position of the second camera lens.

14. The semiconductor device according to claim 9, wherein the host controller acquires the camera shake state data and calculates target positions of the first and second camera lenses.

15. The semiconductor device according to claim 9, wherein the first semiconductor chip is a primary, and the second semiconductor chip is a secondary.
